(19) United States
(12) Patent Application Publication
(10) Pub. No.: US 2003/0095401 A1
(43) Pub. Date: May 22, 2003

(54) Non-visible light display illumination system and method

(75) Inventors: William Robert Hanson, Mountain View, CA (US); Howard William Stanley, San Jose, CA (US); Yoon Kean Wong, Redwood City, CA (US)

Correspondence Address: FOLEY & LARDNER, 777 EAST WISCONSIN AVENUE, SUITE 3800, MILWAUKEE, WI, 53202-5308, US

(73) Assignee: Palm, Inc.

(21) Appl. No.: 09/989,273

(22) Filed: Nov. 20, 2001

(51) Int. Cl. F21V 9/16

(52) U.S. Cl. 362/84; 362/555; 362/561

(57) ABSTRACT

A lighting system for a display is disclosed. The lighting system includes a light source providing invisible light having a wavelength in a spectrum not visible to the human eye. The lighting system also includes a reflective layer having at least one of a phosphorescent and a fluorescent surface reflecting the invisible light from the light source and converting the invisible light into visible light, visible to the human eye. Further, the lighting system includes a display layer in which pixels of the display layer may be altered by applying an electrical charge to the display layer in a controlled manner. The display layer is illuminated by the visible light from the reflective layer.

### BACKGROUND

The present invention relates generally to the field of electronic displays. In particular, the invention relates to front light and back light display systems in which a fluorescent or phosphorescent reflective layer is used to provide illumination of a display layer.

In conventional electronic displays, such as, but not limited to conventional reflective or transflective displays, like liquid crystal displays (LCDs), light emitting diodes (LEDs), cold cathode fluorescent lamps (CCFLs), or the like, are used to provide illumination to the displays. The LEDs or other visible light sources may be distributed around the perimeter of the LCD layer. Light from the LEDs may be dispersed by a plurality of reflective surfaces or a reflective layer provided over, under, or adjacent the LCD layer. Because the LEDs conventionally emit visible light, the LED sources may produce hot spots, or portions of the display which appear to be more highly lit, washed out, or which generally show uneven illumination of the display.

Because typical LEDs, especially when used with lower power devices, such as handheld computers, and the like, exhibit such limitations in lighting and unevenness in illumination, the present invention seeks to provide a solution to the disadvantages of traditional LCD display lighting systems. Accordingly, there is a need for an improved illuminated display that is illuminated with relative evenness over the entire display screen. There is also a need for a display illumination system that utilizes light having wavelengths outside of the conventional visible spectrum. Further, there is a need for a display system utilizing LEDs that emit invisible light and utilize a fluorescent or phosphorescent reflector that converts the light to visible wavelengths and provides illumination to a display layer.

It would be desirable to provide a system and/or method that provides one or more of these or other advantageous features. Other features and advantages will be made apparent from the present specification. The teachings disclosed extend to those embodiments which fall within the scope of the appended claims, regardless of whether they accomplish one or more of the aforementioned needs.

### SUMMARY

One embodiment of the invention relates to a lighting system for a display. The lighting system includes a light source providing invisible light having a wavelength in a spectrum not visible to the human eye. The lighting system also includes a reflective layer having at least one of a phosphorescent and a fluorescent surface reflecting the invisible light from the light source and converting the invisible light into visible light visible to the human eye. Further, the lighting system includes a display layer in which pixels of the display layer may be altered by applying an electrical charge to the display layer in a controlled manner. The display layer is illuminated by the visible light from the reflective layer.

Another embodiment of the invention relates to a method of producing an image on a display. The method includes generating a source of invisible light. The light has a wavelength in a spectrum not visible to the human eye. The method also includes distributing the invisible light over the surface of a reflective layer. The reflective layer includes at least one of a phosphorescent and a fluorescent surface. Further, the method also includes reflecting the invisible light from the light source by the reflective layer and converting the invisible light into visible light, visible to the human eye. Further still, the method includes illuminating a display element with the visible light, the display element including individually selectable pixel elements.

Yet another embodiment of the invention relates to a display system. The display system includes a light source providing invisible light having a wavelength in a spectrum not visible to the human eye. The display system also includes a light guide, dispersing the invisible light over a defined region. Further, the display system includes a light converter, converting the invisible light to light having a wavelength visible to the human eye. Further still, the display system includes a liquid crystal display layer receiving and transmitting the visible light.

Alternative exemplary embodiments relate to other features and combination of features as may be generally recited in the claims.

### BRIEF DESCRIPTION OF THE DRAWINGS

The invention will become more fully understood from the following detailed description, taken in conjunction with the accompanying drawings, wherein like references numerals refer to like elements, in which:

FIG. 1 is an exploded view of an exemplary lighting system for an electronic display;

FIG. 2 is a partial cross-sectional view of the system of FIG. 1;

FIG. 3 is an exemplary depiction of the direction of light in the display of FIG. 1;

FIG. 4 is a partial exploded view of the display system of FIG. 1;

FIG. 5A is a partial exploded view of an alternative embodiment of an electronic display system; and

FIG. 5B is a detailed view of the lighting system indicated by line 5B-5B of FIG. 5A.

### DETAILED DESCRIPTION OF EXEMPLARY EMBODIMENTS

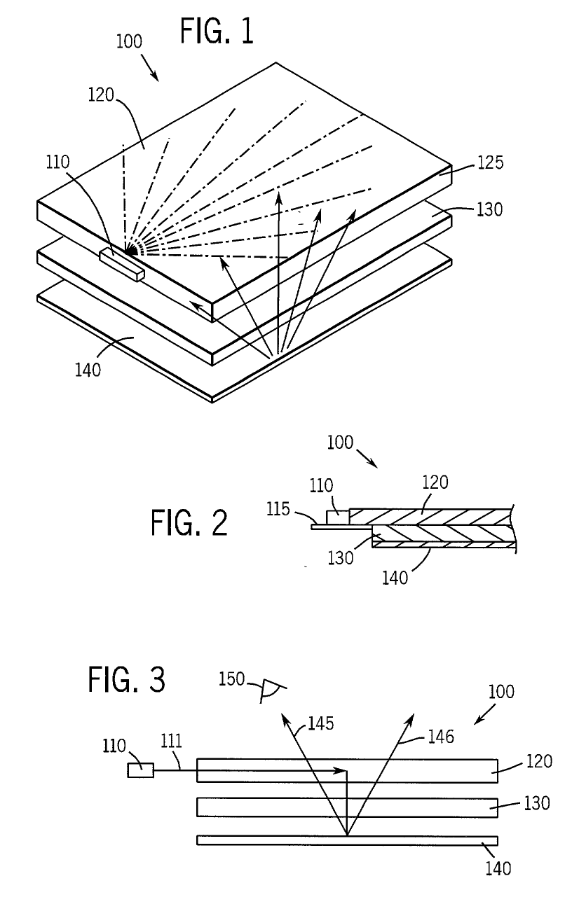

Referring to FIG. 1, an exploded view of a display system 100 is depicted. Display system 100 includes a light source 110 which may be a light emitting diode (LED) or other type of light source capable of providing electromagnetic radiation having wavelengths in the non-visible spectrum (that is approximately having wavelengths less than 430 nanometers (nm) or greater than 690 nm). Such radiation may include, but is not limited to, ultraviolet (UV) and infrared (IR) radiation. Further, other types of light sources beyond LEDs which emit such non-visible radiation may be equally as applicable. For example, a CCFL element with the phosphorescent layer on the lamp surface, not present, or removed, could be used to provide UV radiation. Display system 100 also includes a light guide 120 which may be used to alter the direction and disperse the radiation coming from light source 100.

In a typical illuminated liquid crystal display (LCD) or other type of illuminated display, visible light LEDs may be used in combination with light guides. However, because light emanating from LED 110 is in the visible spectrum, it may appear still that the light is coming from a concentrated or approximate point source, such as LED 110 or multiple LEDs dispersed around the perimeter of the display screen. The use of a visible light source therefore produces a display screen having uneven illumination showing problems with gradation, hot spots, and general uneven illumination. Accordingly, in conventional applications it may be desirable to include-a multiplicity of LEDs dispersed about the perimeter of the display in order to attempt to achieve a more uniform illumination.

Therefore, by utilizing LED 110, which emits non-visible radiation in accordance with the invention, it may be possible to reduce the required number of LEDs without sacrificing the evenness of illumination over the display surface. Utilizing a non-visible light source has the advantage of not causing the appearance of visible light emanating from a point source, and thereby avoiding gradation problems, hot spots, and/or general uneven illumination.

Display system 100 also includes an LCD layer 130. LCD layer 130 may be a conventional LCD layer that provides images thereon in response to electronic input. Further, LCD 130 may be any of a variety of other types of displays, including, but not limited to, E-paper displays, reflective displays, and transflective displays, etc. Display system 100 further includes a reflective layer which receives non-visible light from light guide 120 and converts the received non-visible light into visible light. Reflective layer 140 includes a phosphorescent and/or a fluorescent coating on the surface of layer 140 which both converts and reflects visible light through LCD 130 and through light guide 120 to a viewer's eye.

Referring now to FIG. 2, display system 100 is depicted in a partial cross-sectional view in which the layers of display system 1 00 shown in FIG. 1 are layered one on top of another to form a layered display. LED 110 is depicted as being disposed on a printed circuit board (PCB) 115 or other substrate. LED 110 is depicted being in communication with light guide 120. In an alternative exemplary embodiment, light guide 120 may include edges 125 which may be metallized and/or include a fluorescent or phosphorescent coating to cause reflection and/or conversion of radiation from LED 110. Light guide 120 overlays LCD layer 130 which in turn overlays reflective layer 140. In an alternative embodiment, layer 140 may also include a metallized coating which is configured to improve the reflectiveness of layer 140. However, in some applications a metallized coating or a reflecting coating may not be necessary. Because light guide 120 overlays LCD 130, display 100 may be termed a front light display because the light originates on the same side of LCD 130 as the viewer would view display 100.

Referring now to FIG. 3, a generalized diagram of display 100 is depicted showing the relative directions of light from light source 100 to a viewer 150. In use, light is created by applying an electrical charge to light source 110 to produce a non-visible light 111. Non-visible light 111 enters light guide 120 and is reflected through LCD 130 to reflective layer 140. Reflective layer 140 converts light 111 into a visible light and disperses the visible light in a multiplicity of directions, including, but not limited to, directions 145 and 146. In use, light from reflective layer 140 is either transmitted or absorbed by display 130 to form an image as seen by a user 150.

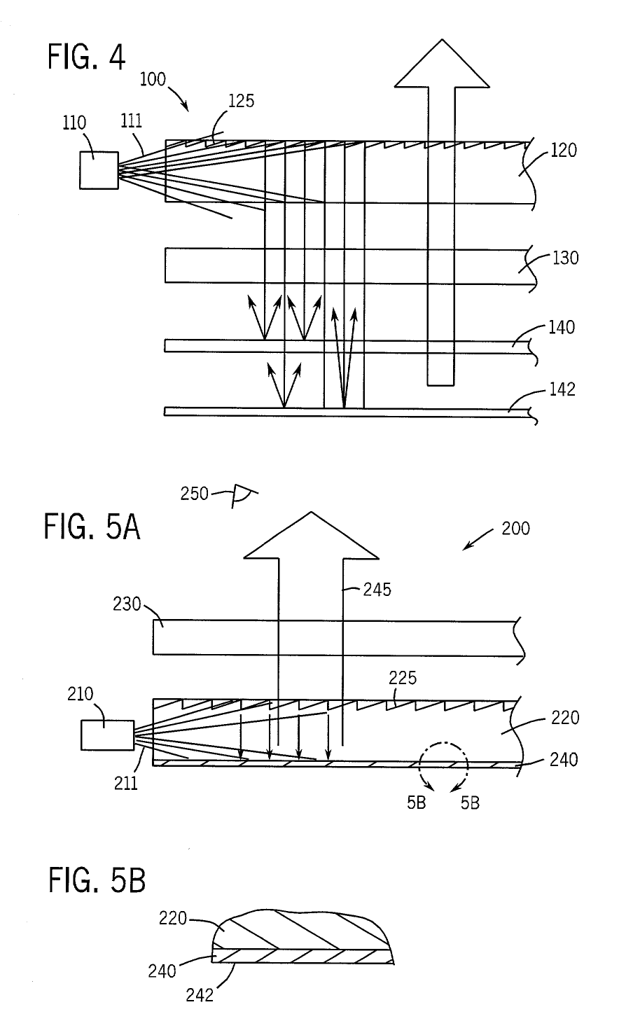

FIG. 4 further depicts a more detailed schematic of display 100 with a light source 110 providing non-visible light to light guide 120. Light guide 120 may include microstructures 125 on at least one surface of light guide 120. Microstructure 125 may be optimized for the frequency of light emitted by LED 110. Microstructures 125 are also configured to redirect the non-visible light through display layer 130 to reflective layer 140. Reflective layer 140 includes a phosphorescent or fluorescent coating and alternatively includes either a reflective coating or a reflective surface 142 below the phosphorescent or fluorescent layer 140. Phosphorescent or fluorescent layer 140 converts incident non-visible light 111 by excitation of phosphorescent or fluorescent coatings in layer 140, thereby causing layer 140 to emit light having wavelengths in the visible spectrum.

Referring now to FIG. 5A, a display system 200 is depicted. Display system 200 is a back light version of display system 100, which has been described as a front light system. Back light system 200 includes an LCD 230 which is on the same side of a light guide 220 as a viewer 250. System 200 also includes a light source, such as LED 210, which provides non-visible radiation 211 into light guide 220 which includes a plurality of microstructures 225 that redirect light onto reflective converting layer 240. Reflective converting layer 240 includes a phosphorescent or fluorescent coating as well as possibly a metallized coating to convert non-visible light 211 into visible light 245 and reflect visible light 245 back through selectively pixelated display layer 230 which selectively absorbs or transmits light 245 to form an image as viewed by a viewer 250.

A detailed view of the lighting system is also shown in FIG. 5B with light guide 220 overlaying converting layer 240 that includes the phosphorescent or fluorescent coating. As well, layer 240 may include and/or be backed by a metallized coating or layer 242 to provide enhanced reflection of visible light which may be generated by phosphorescent coating 240 and/or which may be entering display 200 as ambient light through LCD 230 and light guide 220 to be incident on layer 240. Because it may be possible to easily utilize non-visible light 211 from light sources 110 or 120 and at the same time reflect ambient light off layers 140 or 240, the combined light may improve brightness over displays of the prior art in highly lit conditions, such as in sunlit conditions. Further, because hot spots may be avoided by using non-visible light source, it may be practical to eliminate some of the light sources in conventional displays, thereby providing cost savings, easier manufacturing, and potentially less power usage than current display solutions offer.

While the detailed drawings, specific examples and particular formulations given describe preferred and exemplary embodiments, they serve the purpose of illustration only. The inventions disclosed are not limited to the specific forms shown. The hardware configurations shown and described may differ depending on the chosen performance characteristics and physical characteristics of the display devices. For example, the type of display device used may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. A lighting system for a display, comprising:
a light source providing invisible light having a wavelength in a spectrum not visible to the human eye;
a reflective layer having at least one of a phosphorescent and a fluorescent surface reflecting the invisible light from the light source and converting the invisible light into visible light visible to the human eye; and
a display layer in which pixels of the display layer may be altered by applying an electrical charge to the display layer in a controlled manner, the display layer being illuminated by the visible light from the reflective layer.

2. The lighting system of claim 1, wherein the light source includes a light guide.

3. The lighting system of claim 1, wherein the light source is provide above the display layer.

4. The lighting system of claim 1, wherein the light source is provided below the display layer.

5. The lighting system of claim 1, wherein the reflective layer includes phosphorescent coatings on a substrate.

6. The lighting system of claim 1, wherein reflective layer includes metallized coatings on a substrate.

7. The lighting system of claim 1, wherein the reflective layer includes fluorescent coatings on a substrate.

8. The lighting system of claim 1, wherein the light source includes a light emitting diode (LED).

9. The lighting system of claim 1, wherein the light source provides at least one of ultraviolet (UV) light and infrared (IR) light.

10. A method of producing an image on a display;
generating a source of invisible light, the light having a wavelength in a spectrum not visible to the human eye;
distributing the invisible light over the surface of a reflective layer, the reflective layer including at least one of a phosphorescent and a fluorescent surface;
reflecting the invisible light from the light source by the reflective layer;
converting the invisible light into visible light visible to the human eye; and
illuminating a display element with the visible light, the display element including individually selectable pixel elements.

11. The method of claim 10, wherein the source of light includes a light emitting diode (LED).

12. The method of claim 10, wherein the invisible light includes light having wavelengths in the ultraviolet (UV) spectrum.

13. The method of claim 10, wherein the invisible light includes light having wavelengths in the infrared (IR) spectrum.

14. The method of claim 10, wherein the reflective layer includes a metallized surface.

15. The method of claim 10, wherein the display element is a liquid crystal display element.

16. The method of claim 10, wherein the display element is an electronic paper (e-paper) display element.

17. A display system, comprising:
a light source providing invisible light having a wavelength in a spectrum not visible to the human eye;
a light guide, dispersing the invisible light over a defined region;
a light converter, converting the invisible light to light having a wavelength visible to the human eye; and
a liquid crystal display layer receiving and transmitting the visible light.

18. The display system of claim 17, wherein the light guide overlays the liquid crystal display.

19. The display system of claim 17, wherein the liquid crystal display overlays the light guide.

20. The display system of claim 17, wherein the light converter includes phosphorescent coatings on a substrate.

21. The display system of claim 20, wherein the light converter includes metallized coatings on the substrate.

22. The display system of claim 17, wherein the light converter includes fluorescent coatings on a substrate.

23. The display system of claim 23, wherein the light converter includes metallized coatings on the substrate.

24. The display system of claim 17, wherein the light source and light guide combine to form a front lighting system.

25. The display system of claim 17, wherein the light source and light guide combine to form a back lighting system.

26. The display system of claim 17, wherein the light source includes a light emitting diode (LED).

27. The display system of claim 17, wherein the light source provides at least one of ultraviolet (UV) light and infrared (IR) light.
